(19) United States
(12) Patent Application Publication
(10) Pub. No.: US 2008/0223530 A1
(43) Pub. Date: Sep. 18, 2008

(54) SHADE COVER ATTACHMENT FOR BLIND

(76) Inventor: Vincent Grosso, West Coxsackie, NY (US)

Correspondence Address: HOFFMAN WARNICK LLC, 75 STATE STREET, 14TH FLOOR, ALBANY, NY, 12207, US

(21) Appl. No.: 12/046,925

(22) Filed: Mar. 12, 2008

Related U.S. Application Data
(60) Provisional application No. 60/894,502, filed on Mar. 13, 2007.

(51) Int. Cl. E06B 9/38

(52) U.S. Cl. 160/219; 160/405

(57) ABSTRACT

The present invention is directed to an apparatus, system, and method for attaching a shade cover, of singular or multi-piece construction, to a blind, such as a window Venetian blind. An apparatus for attaching the shade cover to the window blind may include: first attachment means that is configured to attach to the shade cover, and second attachment means, that is operatively attached to the first attachment means, wherein it is also configured to attach to the window blind, rendering the shade cover and the window blind as a single monolithic operating unit. The shade cover that employs the attachment apparatus includes: one or more shade elements; a longitudinal element, such as a connecting rod, interconnected through attachment openings along the shade element(s); and a connection assembly that includes: a penannular element configured to engage with the longitudinal element and/or the shade element(s); and a substantially horizontal extension, that extends distally from a first opening on the penannular element, the substantially horizontal extension including a second opening, configured to engage with a ladder assembly of a typical Venetian blind.

### CROSS-REFERENCE TO RELATED APPLICATIONS

This non-provisional patent application claims priority to U.S. provisional patent application Ser. No. 60/894,502, entitled APPARATUS, SYSTEM AND METHOD FOR ATTACHING A SHADE COVER TO A BLIND, filed on Mar. 13, 2007, the contents of which are hereby incorporated by reference in their entirety.

### BACKGROUND OF THE INVENTION

1. Technical Field

The present invention relates generally to window coverings and, more specifically, relates to an apparatus, system, and method for attaching a shade cover to a blind, such as a Venetian blind.

2. Related Art

Over the past several years there have been many new proprietary products introduced to the window covering industry. Several of them have created completely new categories within the industry while others have been improvements to existing products. There have also been several hybrid products introduced to the market place in recent years; products that incorporate features of two different types of products. These products have garnered a lot of attention but usually have a very complicated manufacturing process and/or are not very reliable thereby inhibiting chances to have significant commercial success.

Accordingly, there is an opportunity for solutions that improve upon current window covering art.

### SUMMARY OF THE INVENTION

The present invention includes a first aspect that provides an apparatus for attaching a shade cover to a window blind comprising: first attachment means configured to attach to the shade cover; and second attachment means, operatively attached to the first attachment means, configured to attach to the window blind, thereby rendering the shade cover and the window blind as a single operating unit

A second aspect of the present invention provides a window covering and window blind system comprising: a window blind, wherein the window blind comprises: a plurality of substantially horizontal slats; a means for lifting the slats; and a means for supporting the slats; a window covering wherein the window covering comprises: at least one cover section; a plurality of attachment elements displaced along the cover section; and an apparatus comprising: a first attachment means configured to attach to the attachment elements; and a second attachment means, operatively attached to the first attachment means, configured to attach to the window blind.

A third aspect of the present invention provides a window covering and window blind system comprising: a window blind, wherein the window blind comprises: a plurality of substantially horizontal slats; means for lifting the slats; and means for supporting the slats; a window covering wherein the window covering comprises: at least one cover section; a plurality of attachment elements displaced along the cover section; and an apparatus comprising: first attachment means configured to attach to the attachment elements; and second attachment means, operatively attached to the first attachment means, configured to attach to the window blind.

A fourth aspect of the present invention provides a apparatus for attaching a window shade cover to a window blind, the window shade comprising a substantially opaque shade element and a plurality of semi-rigid rib elements displaced along the shade element, the window blind comprising a plurality of blinds and means for lifting said plurality of blinds, the apparatus comprising: a compression element configured to compressively attach around at least one of the semi-rigid rib elements; and an attachment extension, extending from the compression element, the attachment extension including an opening, configured to removably attach to the means for lifting.

A fifth aspect of the present invention provides a shade cover for attaching to a blind, the blind including a plurality of horizontal slats interposed via a ladder assembly, the shade cover comprising: a first shade element and a second shade element, each having two longitudinal edges, the two longitudinal edges including a plurality of attachment openings; a longitudinal element interconnected through the plurality of attachment openings of adjacent longitudinal edges of the first and the second shade elements, thereby defining a longitudinal seam between the first shade element and the second shade element; and a connection assembly comprising: a penannular element configured to engage with one of: the longitudinal element, the first shade element, or the second shade element; and a substantially horizontal extension, extending distally from a first opening on the penannular element, the substantially horizontal extension including a second opening, configured to engage with the ladder assembly.

The illustrative aspects of the present invention are designed to address at least one of the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an exploded perspective view of a shade cover and blind system in accordance with an embodiment of the present invention.

FIGS. 2A and 2B depict sectional elevations of a shade cover and blind, respectively, in accordance with an embodiment of the present invention.

FIG. 3A depicts a sectional elevation of the shade cover and blind system in FIG. 1 in a descended and open position, in accordance with an embodiment of the present invention.

FIG. 3B depicts a sectional elevation of the shade cover and blind system in FIG. 1, in a fully collapsed position, in accordance with an embodiment of the present invention.

FIG. 3C depicts a sectional elevation of the shade cover and blind system in FIG. 1, in a descended and closed position, in accordance with an embodiment of the present invention.

FIGS. 4A-4D depict close-up, side, top, and front perspective views, respectively, of an attachment clip for the system in FIG. 1, in accordance with an embodiment of the present invention.

FIG. 5 depicts a perspective view of a connector rod, in accordance with an embodiment of the present invention.

FIG. 6 depicts an exploded view of a shade cover assembly, in accordance with an embodiment of the present invention.

FIG. 7 depicts a back view of a shade cover assembly, in accordance with an embodiment of the present invention.

FIGS. 8A and 8B depicts close-up sectional elevation and top view, respectively, of an attachment assembly, in accordance with an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As detailed herein, the present invention provides for various improvements to the art of window coverings. Aspects of the invention include a unique apparatus for facilitating attaching a shade cover to a blind, a unique shade cover that employs the apparatus, a method for attaching the shade cover (e.g., Roman Blind Cover) to the blind (e.g., Venetian Blind), and a system that includes the apparatus, unique shade cover and blind.

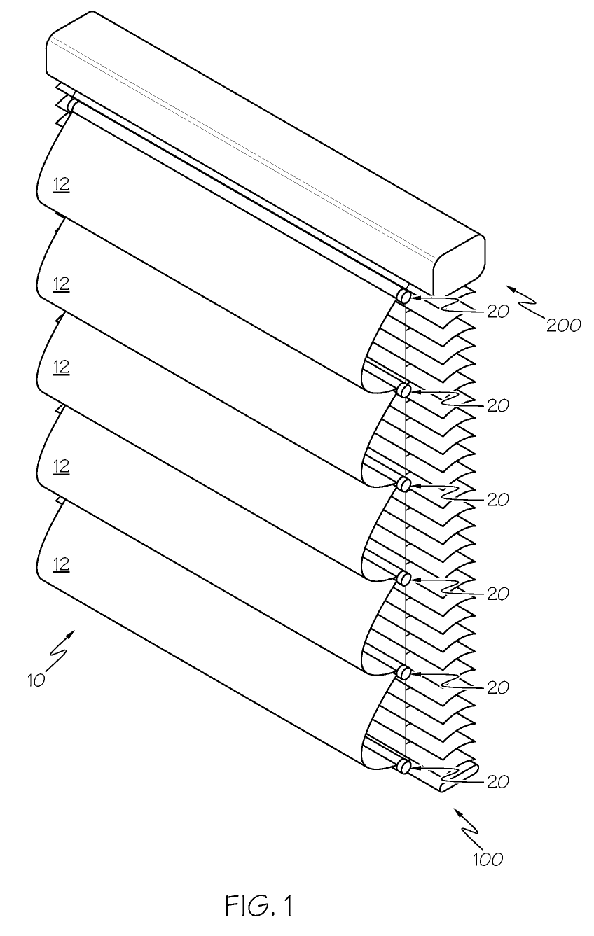

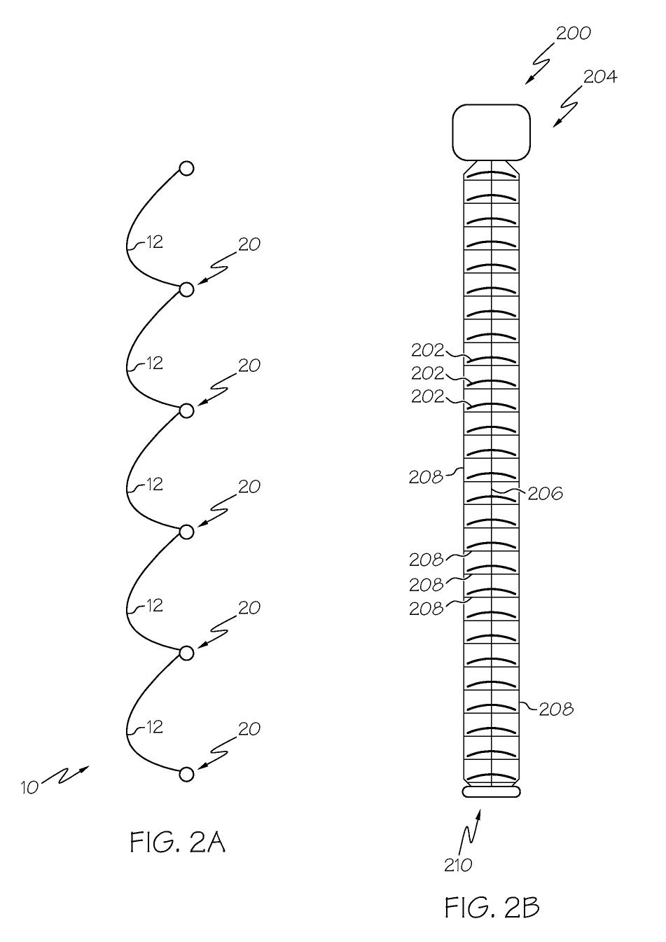

Referring to FIGS. 1, 2A and 2B, aspects of the invention provide for, amongst other features, the ability to attach a shade cover (e.g., a Roman Blind Cover) to a blind (e.g., Venetian Blind). The shade cover 10 may be attached, removably or fixedly, to a blind assembly 200 thereby constituting a shade cover and blind system 100 in accordance with the present invention. The shade cover 10 may be manufactured contemporaneously with or separately from the blind assembly 200. For example, the shade cover 10 may be installed to a pre-existing blind assembly 200 already installed at a window (not shown). Similarly, the entire system 100 may be manufacture and/or sold as a single, monolithic unit. Further, an embodiment allows removable attachment of the shade cover 10 from the blind assembly 200 thereby aiding access to, cleaning, maintenance, etc. of the blind assembly 200, shade cover 10, and/or window.

The blind assembly 200 may constitute any now known or later developed substantially horizontal blind assembly 200. For example, as shown in FIG. 2B, the blind assembly 200 includes a plurality of slats, or blind elements 202 typically displaced in a stacked, horizontal arrangement, wherein a ladder braid system 208 provides for spacing of and aids in lifting/lowering of the slats 202. The blind assembly 200 may further comprise a head rail housing 204 that houses lift and/or tilt mechanisms (not shown). A lift cord 206 connected to a bottom rail 210 when activated via the lift mechanism, and operating in consort with ladder braid system 208 provides for the systematic and orderly lowering and raising of the plurality of slates 202. Similarly, operation of the tilt mechanism provides for the rotation (about longitudinal axes) of the plurality of slats 202 thereby allowing a user to adjust the opacity/light from the window, beyond the blind assembly 200, into the room.

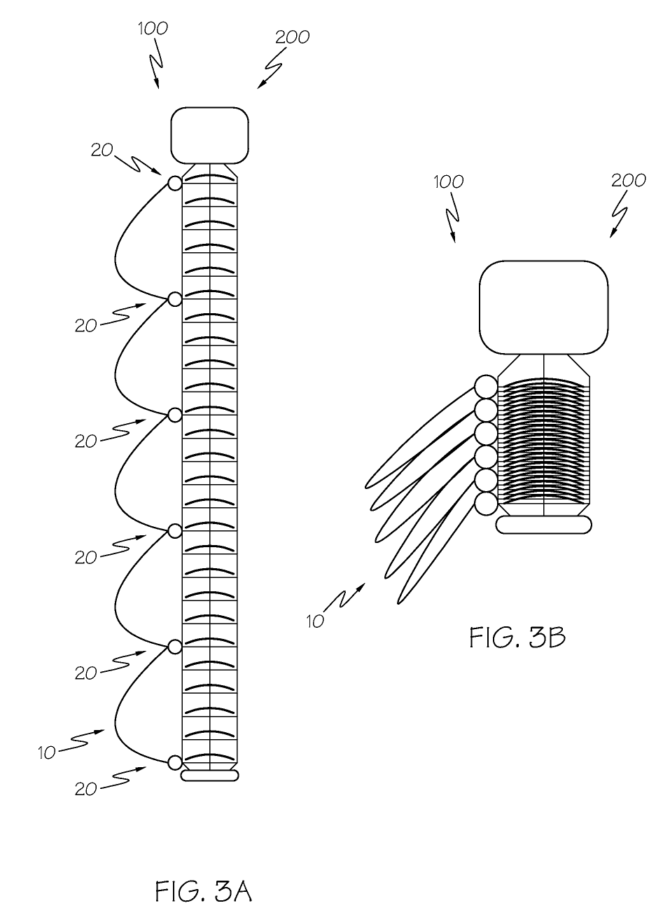

The shade cover 10 comprises one or more shade pieces, or panels 12 and a plurality of connection assemblies 20 that provide for fixed or removable attachment to the blind assembly 200 (FIG. 2A). Referring to FIGS. 3A through 3C, the shade cover and blind system 100, once assembled, allows a shade cover 10, for example a Roman Blind Cover 10, to be connected to portions of the blind assembly 200. In this manner, when the blind assembly 200 is in a descended and open position (FIG. 3A), the Roman Blind Cover 10 is able to maintain a desired hobbled appearance. FIG. 3B shows the blind assembly 200 and Roman Blind Cover 10 in a fully collapsed position, while FIG. 3C shows the system 100 in a fully descended, but closed position, wherein the slats 202 are rotated so as to close the blind assembly 200. It should be apparent to one in the art, that although a shade cover 10 that has a hobble configuration is shown, clearly other presentations and configurations of shade covers 10 are available under the present invention including, for example, flat shade panels 12. Similarly, other positions of the shade cover 10 and blind assembly 200 are possible via adjustment of the blind assembly 200.

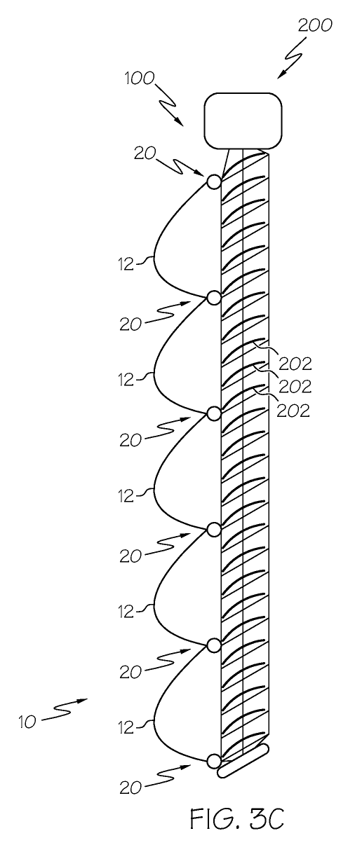

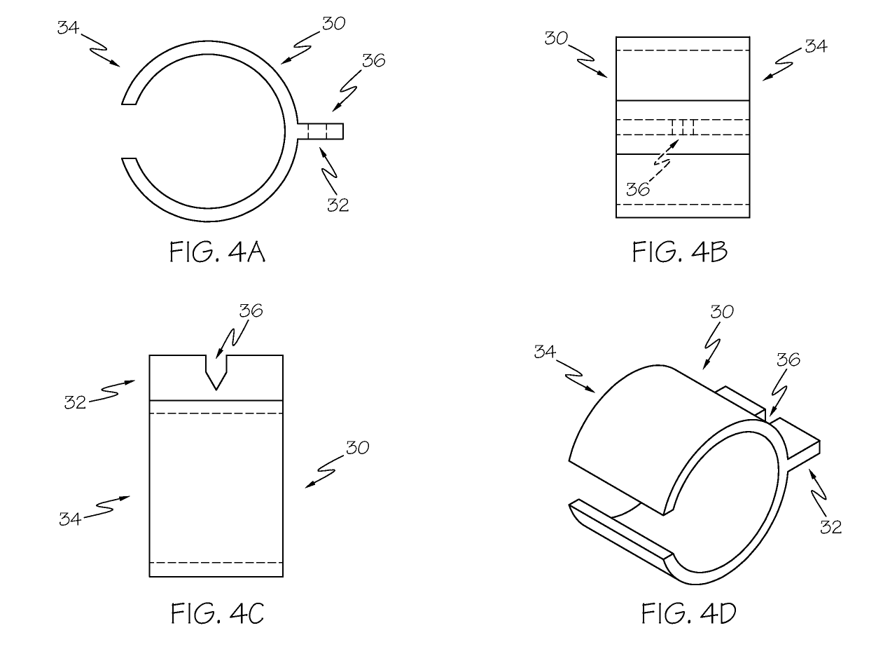

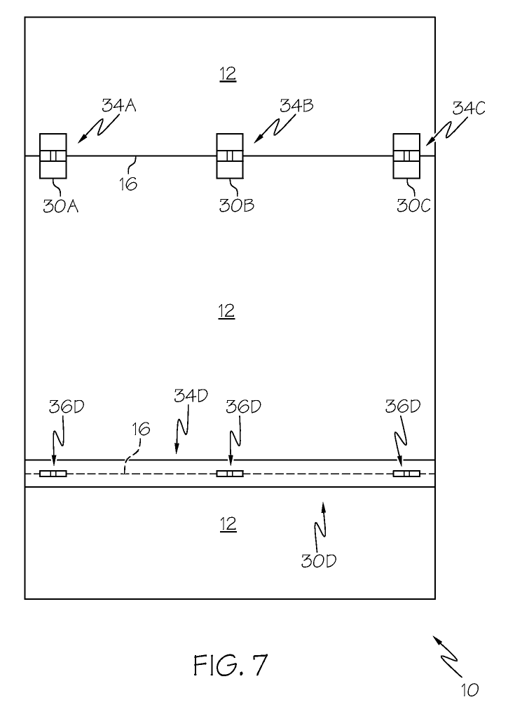

The connection assemblies 20 (see e.g., FIGS. 3A, 3C) comprise an attachment clip 30 and a connector rod 40 (FIG. 5) that are configured to join two adjoining shade panels 12 and/or provide means for attaching the shade panel 10 to a blind assembly 200. An embodiment of an attachment clip 30 is shown in FIGS. 4A through 4D, which show close-up side, front, top, and perspective views, respectively. The clip 30 may include a first means 34 for attaching the attachment clip 30 to at least one of the shade cover 10, shade panel(s) 12, and/or connector rod 40. The first attachment means 34 may include, for example, a circular, annular, penannular, or suitably shaped element for attaching the attachment clip 30 to the connector rod 40 and/or fabric panel(s) 12 of the blind cover 10. In this manner, the attachment clip 30 can be affixed, attached, or removably attached, to the blind cover 10. The attachment clip 30 may further comprise an extension 32 that extends distally from the first attachment means 34 that may further comprise a second attachment means 36 that comprises, for example, a slot, slit, gap, hole, and/or the like that is suitably shaped for attaching, affixing, and/or removably attaching the attachment clip 30 to a portion of the blind assembly 200 (FIG. 1). For example, as shown in FIG. 4C, the second attachment means 36 may comprise a slit that allows for a removable attachment (e.g., friction fit) to a vertical portion of the ladder braid system 208 of the blind assembly 200 (see e.g., FIG. 8B). In this manner, the attachment clip 30 provides for the attachment (removable or fixed) of the shade cover 10 to blind assembly 200. Other configurations of the second attachment means 36 may include, for example, an opening having a closable means (e.g., clasp, tie-down, flap, etc.) that allows the attaching (and/or removal) of the attachment clip 30, and concomitant shade cover 10, to (and/or from) the blind assembly 200.

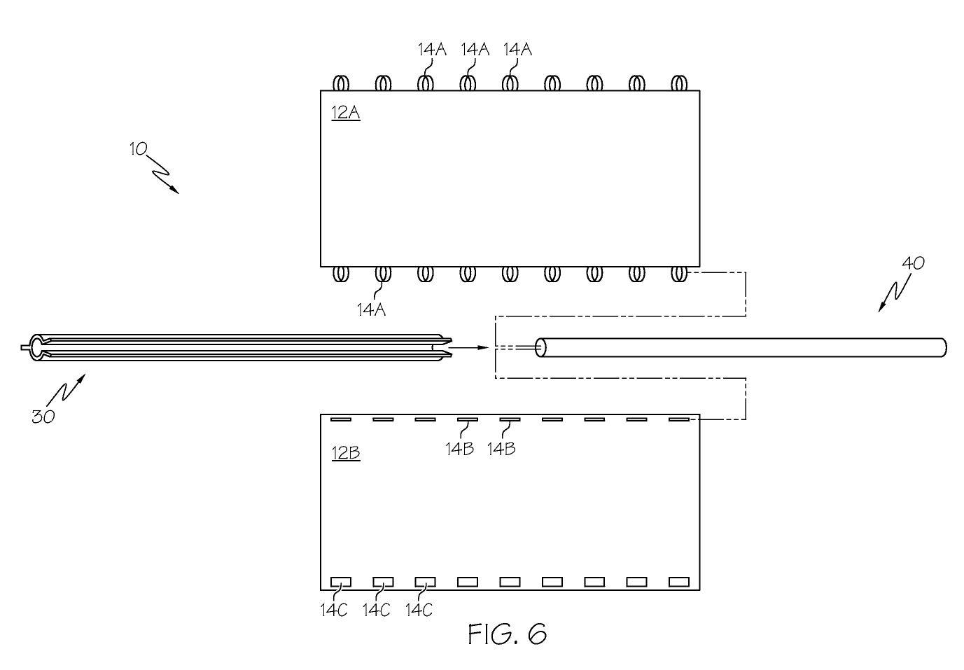

FIG. 5 shows a perspective view of a connecting rod 40 in accordance with an embodiment of the present invention. The connecting rod 40 may comprise any elongate member that is suitable for the function described herein. Although, the connecting rod 40 is shown as circular in cross-section, any cross-sectional shape may be employed. Similarly, although the connecting rod 40 shown is solid in cross-section, a hollow construct is acceptable. Any suitable material or combinations of materials may be used for the connecting rod 40. For example, various flexible but rigid or semi-rigid plastics may be used for the connecting rod 40. In an embodiment, the length of the connecting rod 40 may extend the full width of the shade cover 10 and window. Alternatively, the connecting rod 40 may be of shorter or longer length. For example, the connecting rod 40 may be only as wide as a single clip element (see e.g., 30A, 30B, 30C in FIG. 7).

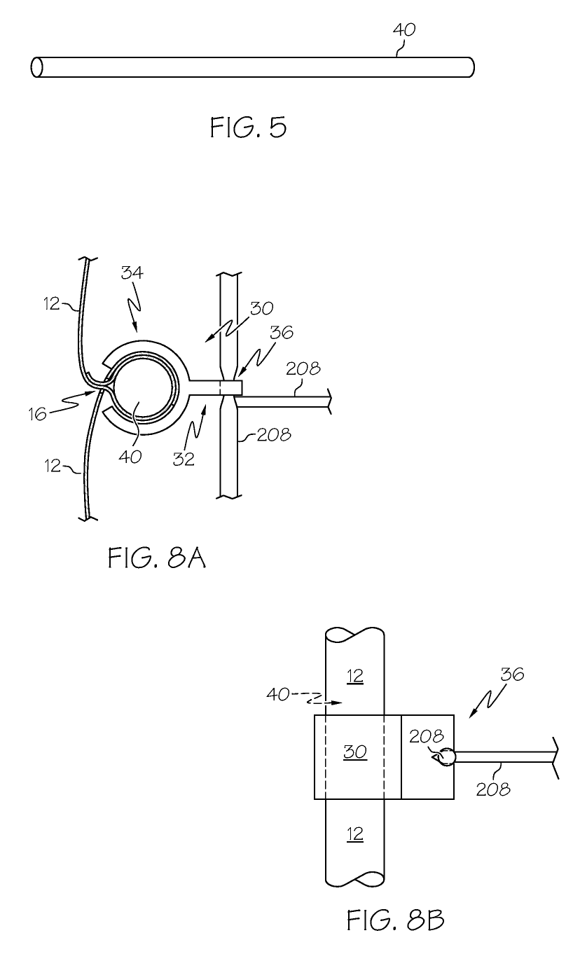

FIG. 6 depicts an exploded view of an embodiment of a shade cover 10 in accordance with the present invention. As shown, two adjacent shade pieces 12A, 12B may be joined via the interconnection of the clip element 30, the connecting rod 40 and a series or plurality of connecting openings 14. The longitudinal edge of the shade pieces 12 may include the connecting openings 14. As shown, various configurations of connecting openings 14 are available under the present invention including, for example, loops 14A, slits 14B, holes 14C, and/or the like. In other embodiments, the connecting rod 40 may be attached to the shade pieces 12 by other means now known or later developed. For example, the connecting rod 40 may be glued, stapled, adhered, and/or the like to the shade pieces 12. The connector rod 40 may, for example, interweave through the connecting openings 14, thereby attaching adjacent shade pieces 12A, 12B. Further, the clip element 30 and its first attachment means 34 (see e.g., FIG. 4A) are connected around at least one of the shade pieces 12A, 12B, and/or the connector rod 40. In this manner, a monolithic shade cover 10 is created.

As shown in FIG. 7, one or more shade pieces 12 may be connected to each other to form the shade cover 10. For example, an embodiment is shown wherein three (3) distinct clip elements 30A, 30B, 30C are attached to the shade cover 10 wherein the clip elements 30A, 30B, 30C are dispersed along a longitudinal edge of two shade pieces 12 thereby forming a seam 16 therebetween. In another embodiment, a single clip element 30D extends substantially the full width of the shade cover 10, shade pieces 12, and/or connector rod 40. Extending from the clip element 30D, at suitable locations to align with portions of the ladder braid system 208 (FIG. 2B), are a plurality of second connection means 36D. Clearly, various configurations beyond those depicted are available under the present invention. For example, different quantities of connection assemblies 20 and/or clip elements 30 that just those shown in FIG. 7. Similarly, the first connection means 34 and second connection means 36 may extend different lengths in various embodiments.

FIGS. 8A and 8B show close-up views of an embodiment of a connection assembly 20. The clip element 30 provides for a connection to the ladder braid system 208 so that when a lift cord 206 (FIG. 2B) is operated to lift/lower the blind 200, the connected shade cover 10 similarly will raiser and/or lower. Connecting the shade cover 10 to the blind creates a monolithic shade cover and blind system 100.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. An apparatus for attaching a shade cover to a window blind comprising:
first attachment means configured to attach to the shade cover; and
second attachment means, operatively attached to the first attachment means, configured to attach to the window blind, thereby rendering the shade cover and the window blind as a single operating unit.

2. The apparatus of claim 1, wherein the second attachment means is removably attached to the window blind.

3. The apparatus of claim 1, wherein the first attachment means includes a compression fitting.

4. A method of attaching a shade cover to a window blind, comprising:
providing the shade cover wherein the shade cover includes:
at least one cover section; and
a plurality of substantially rigid elements displaced along the shade cover;
providing the window blind, wherein the blind includes:
a plurality of substantially horizontal slats;
means for supporting the slats; and
means for lifting the slats;
attaching an apparatus to a least one of the plurality of substantially rigid elements and further attaching the apparatus to at least one of the means for lifting or the means for supporting, whereby upon operating the means for lifting further lifts the shade cover.

5. The method of claim 4, wherein the plurality of substantially rigid elements comprise longitudinal connecting rods.

6. The method of claim 4, the means for supporting the slats comprising a ladder braid system.

7. The method of claim 4, the apparatus comprising:
a penannular element configured to engage with at least one of the at least one cover section or one of the plurality of substantially rigid elements; and
an extension, extending distally from a first opening on the penannular element, the extension including a second opening, configured to engage with at least one of the means for supporting the slats or the means for lifting the slats.

8. The method of claim 7, wherein the penannular element comprising a compression fitting.

9. The method of claim 4, wherein the attaching comprises removably attaching the apparatus.

10. A window covering and window blind system comprising:
a window blind, wherein the window blind comprises:
a plurality of substantially horizontal slats;
means for lifting the slats; and
means for supporting the slats;
a window covering, wherein the window covering comprises:
at least one cover section;
a plurality of attachment elements displaced along the cover section; and
an apparatus comprising:
first attachment means configured to attach to the attachment elements; and
second attachment means, operatively attached to the first attachment means, configured to attach to the window blind.

11. An apparatus for attaching a window shade cover to a window blind, the window shade comprising a substantially opaque shade element and a plurality of semi-rigid rib elements displaced along the shade element, the window blind comprising a plurality of blinds and means for lifting said plurality of blinds, the apparatus comprising:
a compression element configured to compressively attach around at least one of the semi-rigid rib elements; and
an attachment extension, extending from the compression element, the attachment extension including an opening, configured to removably attach to the means for lifting.

12. A shade cover for attaching to a blind, the blind including a plurality of horizontal slats interposed via a ladder assembly, the shade cover comprising:
a first shade element and a second shade element, each having two longitudinal edges, the two longitudinal edges including a plurality of attachment openings;
a longitudinal element interconnected through the plurality of attachment openings of adjacent longitudinal edges of the first and the second shade elements, thereby defining a longitudinal seam between the first shade element and the second shade element; and
a connection assembly comprising:
a penannular element configured to engage with one of: the longitudinal element, the first shade element, or the second shade element; and
a substantially horizontal extension, extending distally from a first opening on the penannular element, the substantially horizontal extension including a second opening, configured to engage with the ladder assembly.
